(19) United States
(12) Patent Application Publication
(10) Pub. No.: US 2010/0146496 A1
(43) Pub. Date: Jun. 10, 2010

(54) Displaying Presentations

(75) Inventors: James Stoddart, Cumming, GA (US); Gary Edward Webb, Cumming, GA (US)

Correspondence Address: James A Stoddart`, 4175 Sinclair Shores Road, Cumming, GA, 30041, US

(73) Assignee: SLIDESHOW TECHNOLOGIES, LLC, Cumming, GA (US)

(21) Appl. No.: 12/629,871

(22) Filed: Dec. 2, 2009

Related U.S. Application Data
(60) Provisional application No. 61/119,055, filed on Dec. 2, 2008.

(51) Int. Cl. G06F 17/00; G06F 21/24; G06F 9/44; G06F 3/048

(52) U.S. Cl. 717/168; 700/94; 726/26; 715/716

(57) ABSTRACT

Included are embodiments of a presentation device. At least one embodiment of the device includes internal memory storage including at least one file; and a processing component coupled to the memory device, the processing component configured to, upon activation of the presentation device, automatically determine whether the at least one file is a compatible file and, in response to determining that the at least one file is a compatible file, automatically convert the at least one file into a sequence of signals that is sent for display as a presentation that includes at least one viewable image.

### CROSS REFERENCE

This application claims the benefit of U.S. Provisional Application No. 61/119,055, filed Dec. 2, 2008. This application also references U.S. patent application Ser. No. 12/417,227, filed on Apr. 2, 2009; and U.S. Provisional Application No. 61/151,227 filed on Feb. 10, 2009.

### BACKGROUND

In many applications, users desire to present graphical images or video with a display device, such as a monitor or projector. For example, this might be for a presentation or a kiosk or signage. These graphical images are contained in data files which typically originate on the user's computer. However, it may not be practical, convenient, or simple to connect that computer to the display device either because of the computer or the location of the display device.

An alternative to connecting the computer to the display device would be an intermediary device. This intermediary device would receive files from the user's computer, convert the files to video signals, and transmit those video signals to a display device through a wired connection.

Attempts have been made to utilize “smart phones” and similar handheld devices as such an intermediate device. In these attempts, the handheld device is used to generate a video image from a data file stored in its memory. Then that video image is transmitted via a wired or wireless connection to a companion electronic device which scales the video image up to the resolution required by the display device. There are three limitations of this approach. First, because handheld devices can not produce high pixel count video images, when the low pixel count video screen image is scaled up for the display, the presented image quality is inadequate. Second, each image displayed requires transmitting a screen image from the handheld to the companion electronic device and then the companion electronic device must scale the image. As a result, transition speed between images or the smoothness of video images may be inadequate. Finally, because handheld devices typically lack the full features and processing power of a computer, displaying the video images requires complex file handling, file manipulation or conversion to alternative formats, and multiple steps for video set up.

Other attempts have created projectors and monitors or devices that connect to projectors and monitors with real time network capability. Via a wireless connection and appropriate software, a user can transmit the video image that is being displayed on their computer screen directly to the projector or monitor. There are four limitations of this approach. First, transporting a computer to a location where it can make the wireless connection may be inconvenient, cumbersome, impractical or expose the computer to the potential of damage or theft. Second, making the wireless connection between the computer and device may be too complex for some users to manage or may require capabilities not contained in their computer. Third, the process of launching software, finding files and synchronizing the computer with the display is complex, time consuming, and at times unreliable. Finally, fourth, this does not provide a solution for the millions of existing projectors and monitors that are in use today.

In addition to simply displaying video images, users may also want to simultaneously display and control video images in multiple locations. Today, users accomplish this with on-line web conferencing services which use software to extract images of a user's computer screen and display a duplicate image on screens of connected users. There are three limitations of this approach. First, the on-line web conferencing software is inherently invasive and thus could allow unintended access to files on a user's computer. Second, using the on-line web conferencing services typically requires paying ongoing subscription fees. Third, use of the on-line web conferencing services may be too complex for some users to access and operate.

Thus, a heretofore unaddressed need exists in the industry to address the aforementioned deficiencies and inadequacies.

### SUMMARY

Included are embodiments of a presentation device. At least one embodiment of the device includes internal memory storage containing at least one file; and a processing component coupled to the memory device, the processing component configured to, upon activation of the presentation device, automatically determine whether the at least one file is a compatible file and, in response to determining that the at least one file is compatible file, automatically convert the at least one file into a sequence of signals that is sent for display as a presentation that includes at least one viewable image; and a wireless or wired connection which allows files to be received from an external source, and receives instruction signals from an external source which instruct the processing component to send a signal containing a certain viewable image for display.

Other embodiments and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

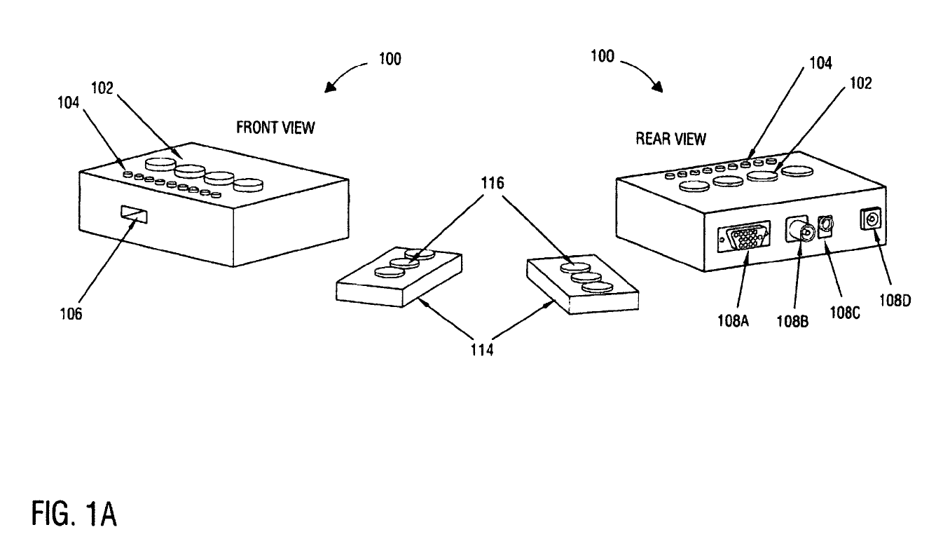

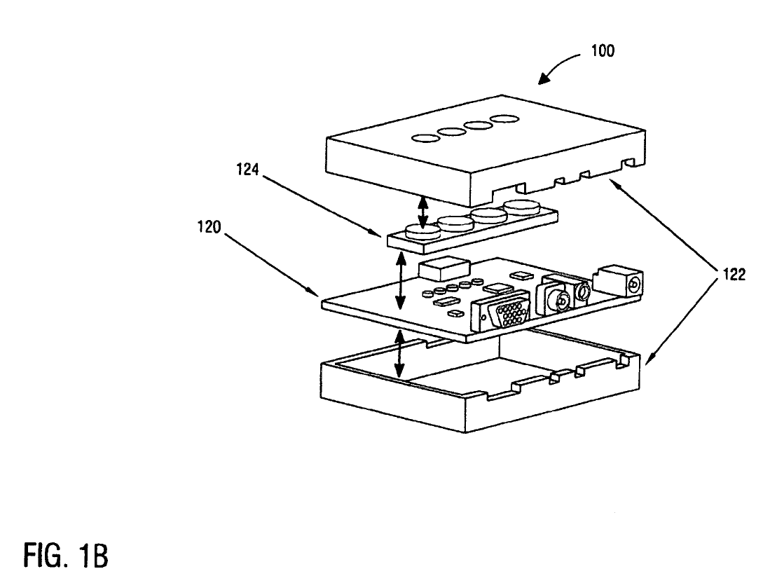

FIG. 1A illustrates an exemplary embodiment of presentation device and remote control.

FIG. 1B illustrates another exemplary embodiment of the presentation device, similar to the diagram from FIG. 1A.

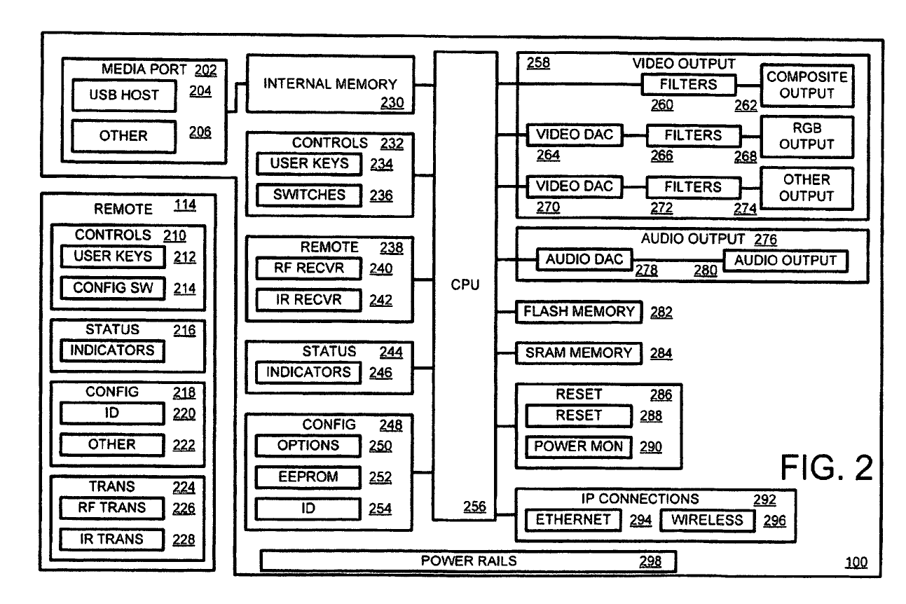

FIG. 2 illustrates an exemplary block diagram, further illustrating internal components of the presentation device from FIGS. 1A and 1B.

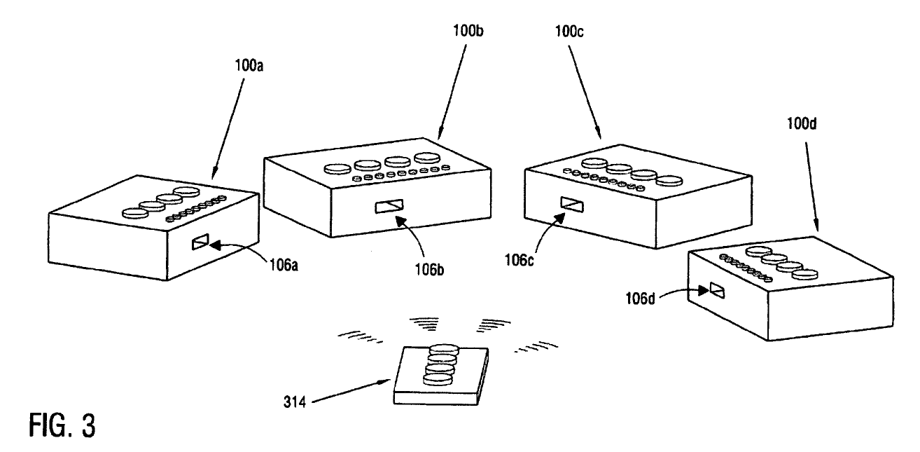

FIG. 3 illustrates a non-limiting example of a configuration that utilizes a plurality of presentations devices, such as the presentation device from FIGS. 1A and 1B.

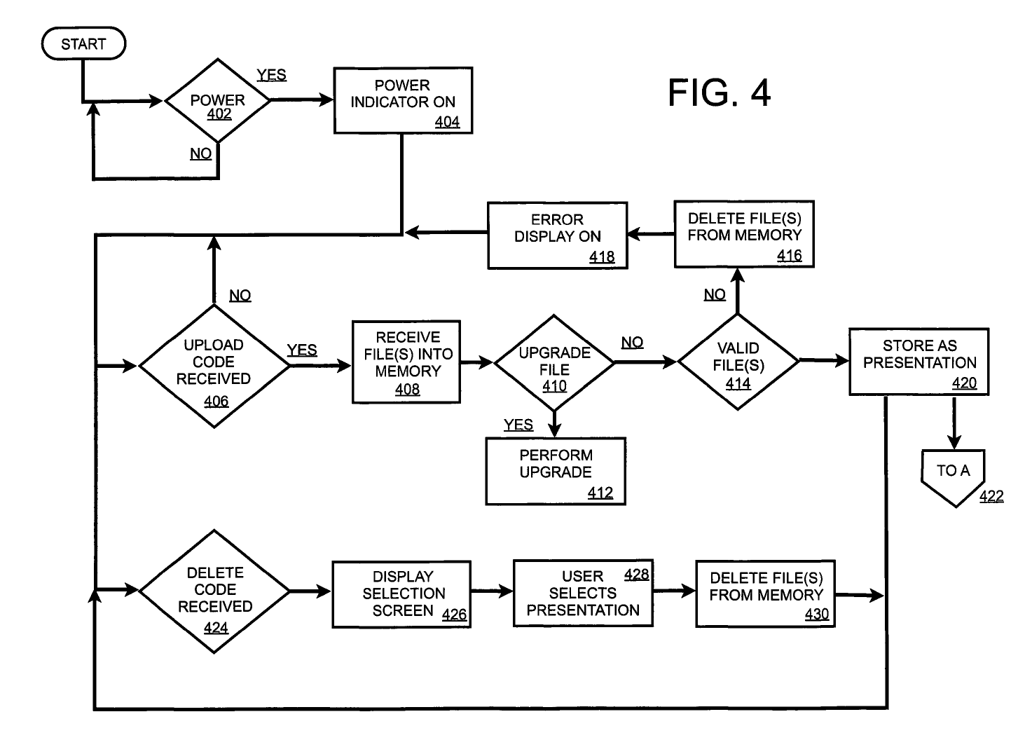

FIG. 4 illustrates an exemplary flowchart for a start-up sequence that may be utilized by a presentation device, such as the presentation device from FIGS. 1A and 1B.

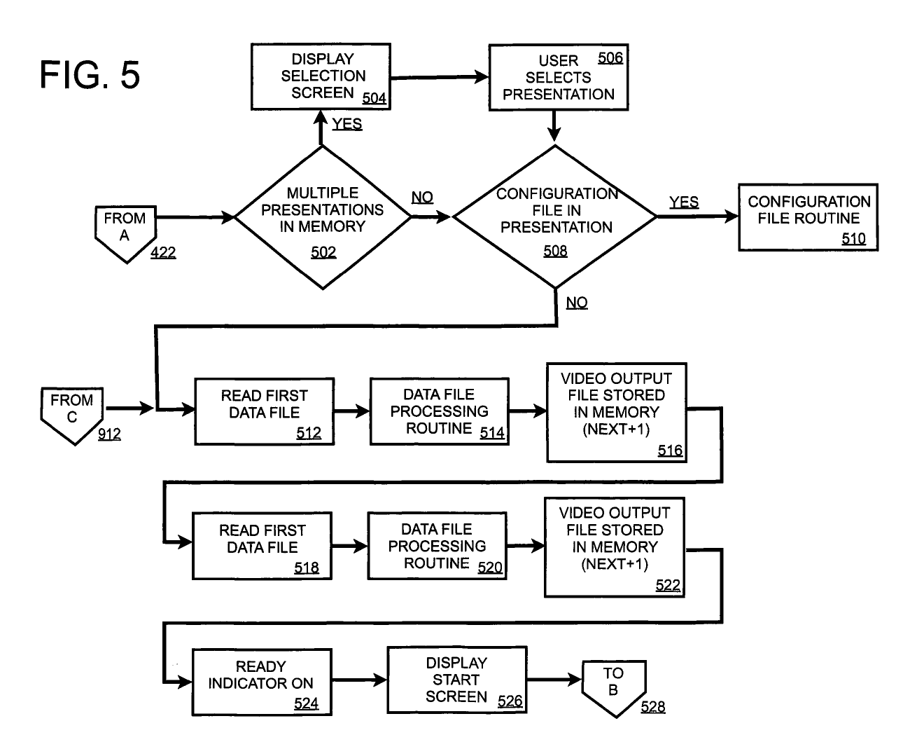

FIG. 5 illustrates an exemplary flowchart for initiating a presentation stored in memory of the presentation device and initial buffering of video, similar to FIG. 4.

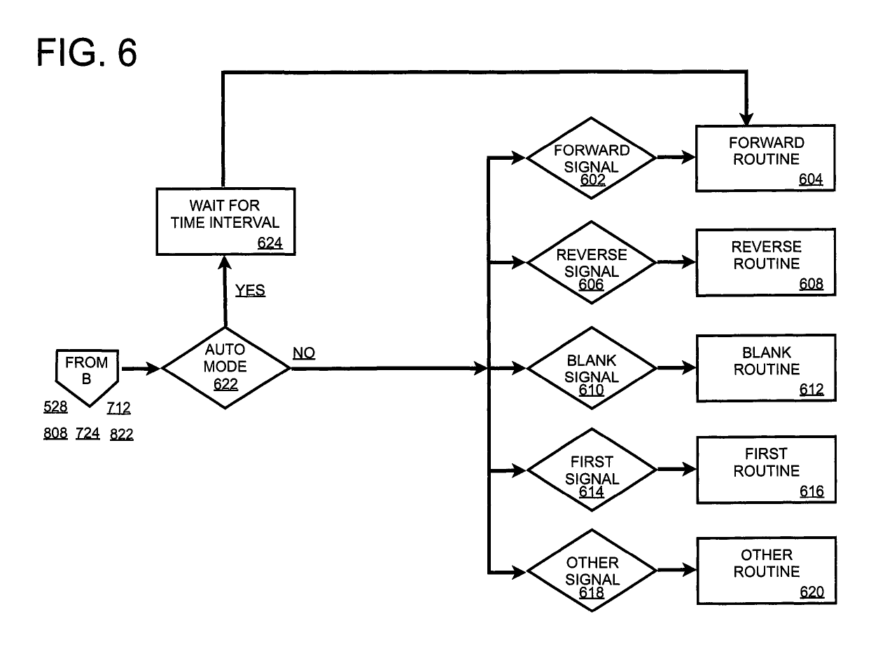

FIG. 6 illustrates an exemplary flowchart describing one or more responses of the presentation device to user inputs, similar to the diagram from FIG. 5.

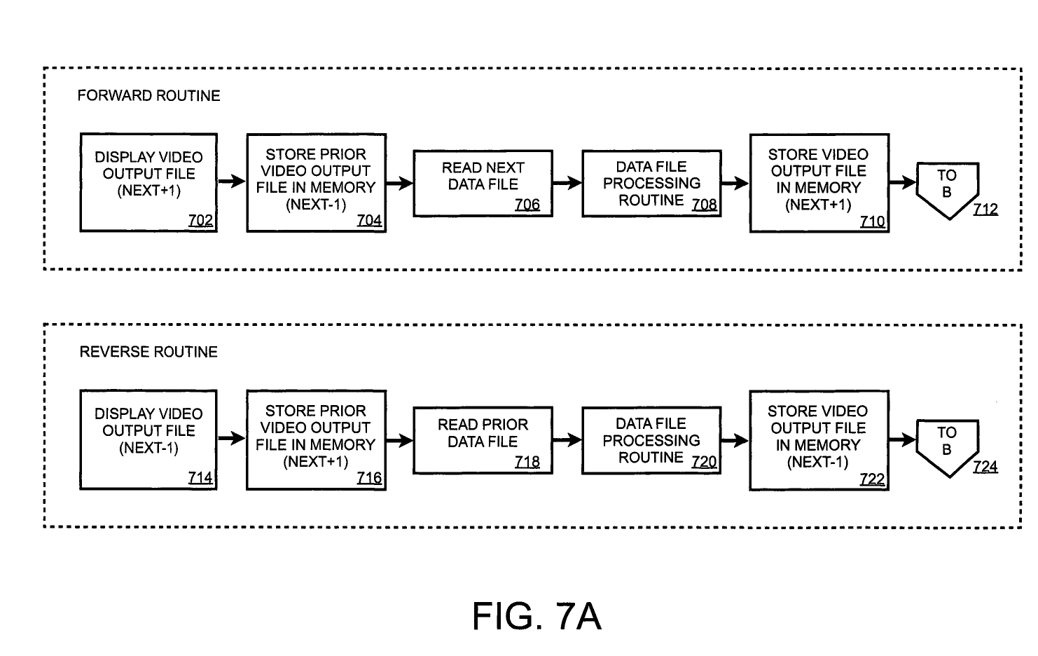

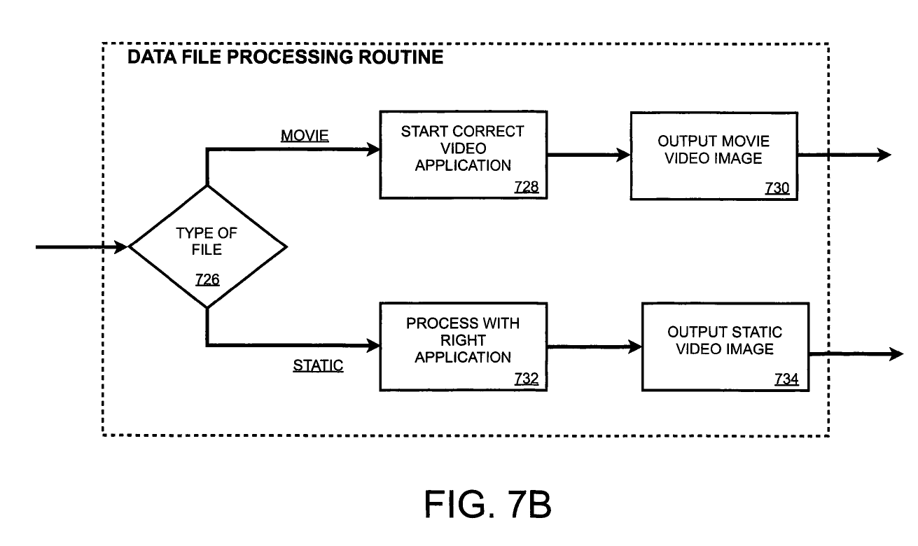

FIG. 7A illustrates exemplary flowcharts for the presentation device to sequence images, similar to the diagram from FIG. 6.

FIG. 7B illustrates an exemplary flowchart for processing images into a video output of the presentation device, similar to the diagram from FIG. 7A.

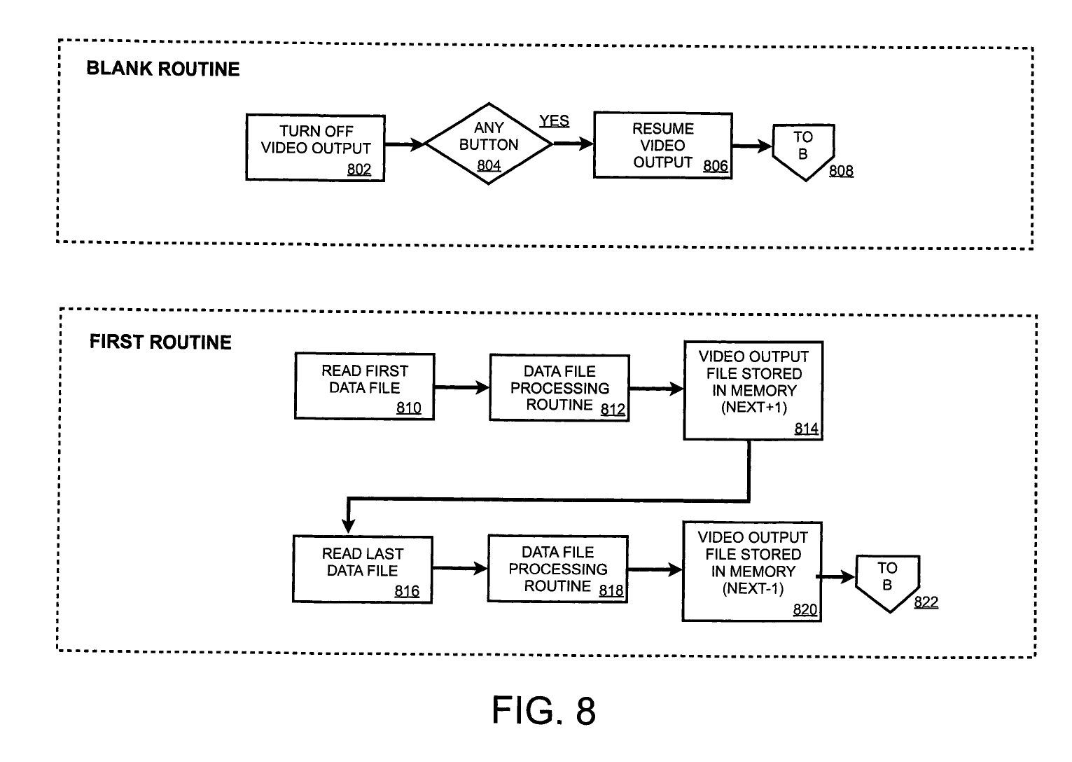

FIG. 8 illustrates an exemplary flowchart for utilizing a blank function and first slide function on the presentation device, similar to the diagram from FIGS. 7A and 7B.

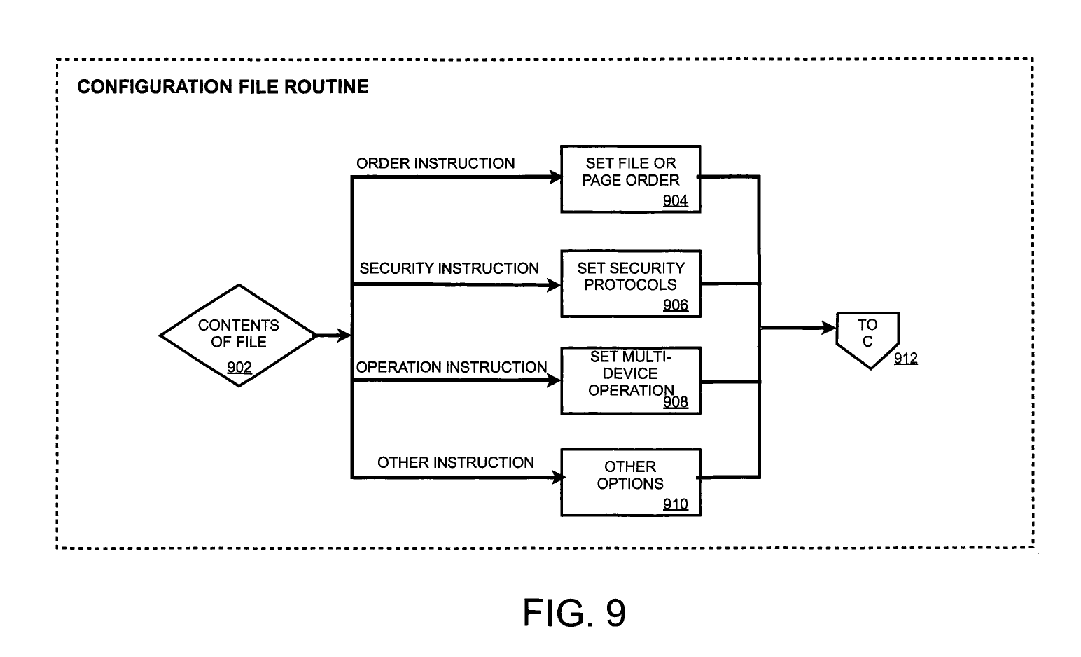

FIG. 9 illustrates an exemplary flowchart for configuration file processing with the presentation device, similar to the diagram from FIG. 8.

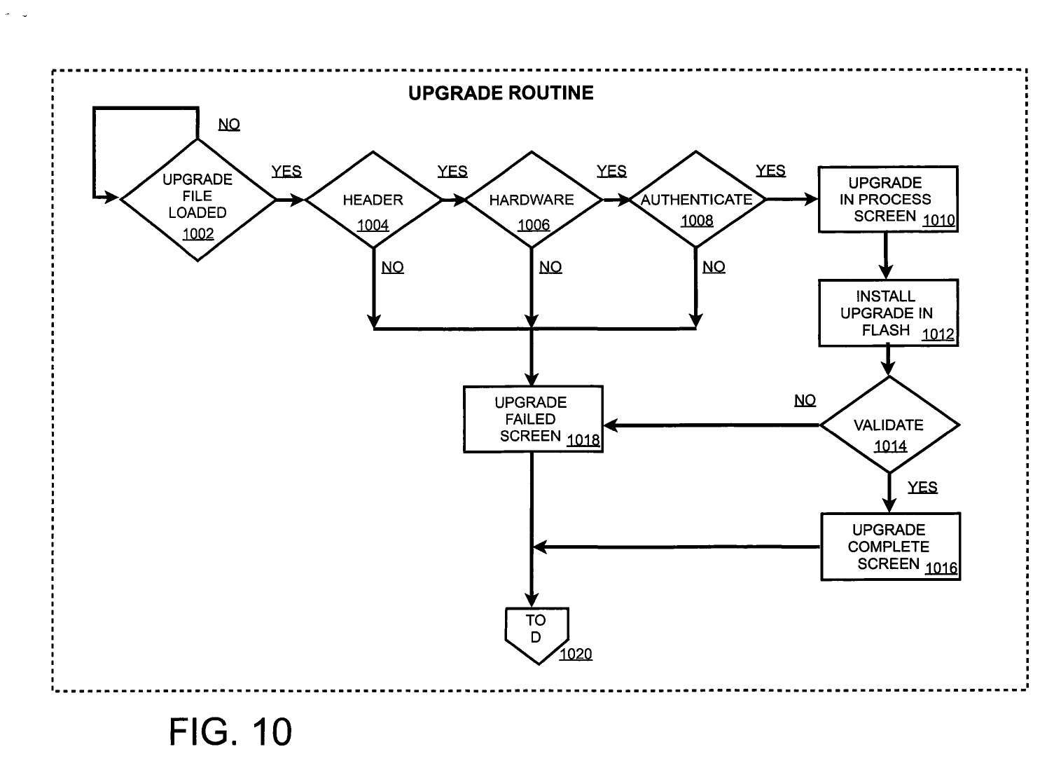

FIG. 10 illustrates an exemplary flowchart of a software update function that may be utilized on the presentation device, similar to the diagram from FIG. 9.

### DETAILED DESCRIPTION

Embodiments described herein provide methods and systems for the display of presentation materials, images, documents and/or full motion video content via a display device, such as a projector or display monitor. At least some of the systems disclosed herein include embodiments of a small portable presentation device that may be removably coupled to the display device. As described in more detail below, the presentation device may be configured to receive and/or store a presentation as a plurality of discrete files and provide at least one viewable image (e.g., still images, video images, etc.) and/or audio of those files as a sequential presentation. Additionally, in some embodiments, the presentation device may be permanently coupled to another device, such as a computer projection device. Similarly, in some embodiments, the presentation device includes a plurality of files in different formats and the presentation device is configured to provide the files for display in a format that provides for a seamless transition between the files. Other embodiments are also contemplated, as discussed below.

With regard to the drawings, FIG. 1A illustrates a perspective view of an exemplary embodiment of a presentation device 100 and remote control unit 114. As illustrated, the presentation device 100 includes user input devices 102, which could take the form of push buttons, switches, etc. The input devices 102 may be configured to provide a user with one or more options for performing various functions. As a non-limiting example, a first input may be configured to cause the presentation device 100 to advance to a next output slide. A second input may be configured to cause the presentation device 100 to advance to a previous output slide. Similarly, a third input may be configured to cause the presentation device to cause the output device to toggle between an on position and an off position, producing a blank screen effect. A fourth input may be configured to cause the presentation device 100 to return to the first output slide of the presentation.

Additional options may also be provided with the presentation device 100. More specifically, the presentation device 100 may be configured to provide one or more options for selection of an automatic or manual mode. In the manual mode, the presentation device 100 may respond to user inputs only. However, the automatic mode may be configured to allow the presentation device 100 to automatically perform a sequence of actions with no user input. Other options may also be included, such as an output display option for changing pixel resolution of the output image.

As also illustrated in FIG. 1A, the presentation device 100 may include one or more indicators 104 for providing status information of the presentation device 100. The indicators 104 may be configured as light emitting diodes (LEDs); however this is a non-limiting example. Similarly, the presentation device 100 may also include a port 106, where a network connection may be coupled to the presentation device 100. The network connection may be configured as a wired connection, however this is a non-limiting example.

The presentation device 100 may also include one or more connections 108a-108d to provide an interface for the output of video and/or audio signals to an external display device such as a projector or digital monitor. The connections 108 may include a composite video connection, a component video connection, a red green blue (RGB) video connection (as a non-limiting example with a video graphics array (VGA) style connector), a high definition media interface (HDMI) video connection, and/or other connections.

The connections 108a-108d may also include audio connections. As a non-limiting example, the connections may be configured for coupling to an amplification device such as speakers, sound systems integral to projectors or monitors, and/or an audio amplifier. These connections may take any of a plurality of forms, such as radio corporation of America (RCA) style connectors, audio jacks, mini-plugs, and/or other audio connectors.

As also illustrated in FIG. 1A, the presentation device 100 may be associated with a remote control unit 114 that may include one or more input controls 116, through which a user can control the presentation device 100 to perform various functions, such as those described above. Additionally, in some embodiments, the remote control unit 114 may be configured to receive presentation advancement data associated with a presentation. More specifically, in such embodiments, the remote control device 114 may receive the advancement data (and/or identifiers associated with the corresponding presentation device 100) for the current presentation. The data may be received via a wired coupling with a personal computer and/or via a wireless connection (e.g., wireless fidelity (Wi-Fi), WiMax, etc.) to a computer that sends the advancement data and device identifiers.

The presentation device 100 may also be associated with other types of devices that provide control instructions. For example, the presentation device 100 may be configured to receive control instructions wirelessly from a computer or handheld phone, or wirelessly from a full keyboard or a specially configured input device suited for a particular application.

FIG. 1B illustrates another perspective view of an exemplary embodiment of the presentation device 100, similar to the diagram from FIG. 1A. One or more circuit boards 120 may be housed within an enclosure 122. As a non-limiting example, the enclosure may be configured as a two piece molded assembly which fits around the electronic board, or could be in the form of an extrusion that the board slides into. The presentation device 100 may also include one or more assemblies 124, which form a user interface. Such assemblies may include membrane switches, individual switches, capacitive switches, slide switches, and/or other components.

FIG. 2 illustrates an exemplary block diagram of a plurality of internal components of the presentation device 100 from FIGS. 1A and 1B. As illustrated, a processor 256 (such as an advanced risk machine (ARM)/digital signal processing (DSP) graphics co-processor, central processing unit (CPU), etc.) reads input files, user inputs and other inputs, and outputs graphics files and other associated data.

A media port 202 may be coupled to the processor, either directly (in the embodiments where the presentation device 100 does not include an internal memory component 230) or indirectly (where the presentation device 100 does include an internal memory component 230). In the exemplary embodiments where the presentation device 100 includes an internal memory component 230, the internal memory component 230 may be directly coupled to the processor 256 and the media port 202 may be directly coupled to the internal memory component 230. The media port may include a USB host 204 and/or other hosts 206.

A controls component 232, which may include user keys 234 and/or switches may 236 be coupled to the processor 256. A remote receiver component 238 may be included as part of the presentation device 100 and coupled to the processor 256. The receiver component may include a radio frequency (RF) receiver 240 and/or an infrared (IR) receiver 242. The remote receiver component 238 may be configured to receive and decode signals from the remote control unit 114 (from FIG. 1A) to control one or more operations of the presentation device 100. The remote receiver component 238 may also be configured to receive signals from other devices, such as computers, handheld devices and other types of devices that can send instructions via a radio frequency or infrared protocol. A status component 244 may be coupled to the processor 256, which may include one or more indicators 246 (similar to the indicators 104, from FIG. 1A). Similarly, a configuration component 248 may be coupled to the processor 256 to control device configuration, such as an options component 250, an EEPROM memory 252 containing configuration information or a device containing an ID 254.

One or more flash memory devices 282 may be included and coupled to the processor 256. The flash memory 282 may contain “embedded” software systems that may be used by the presentation device 100 to perform one or more functions. This embedded software system may be factory loaded; however this is not a requirement. The embedded software system may be built on a standard operating system (such as Linux or Windows CE), and/or could be written as a stand alone system. Similarly, presentation device 100 may include one or more SRAM memory devices 284. The SRAM memory device may be coupled to the processor 256 and configured to provide operational memory for processing or buffering images.

A video output component 258 may also be included and coupled to an output of the processor. The video output component 258 may be configured to provide video signals to external devices (such as a display device). More specifically, in some exemplary embodiments, the video output includes one or more filters 260 that are coupled to a composite output 262. Similarly, some embodiments include a video digital to analog converter (DAC) 264, one or more filters 266, and an RGB output 268. Still some embodiments may be configured with a video DAC 270, one or more filters 272, and one or more other outputs 274.

In operation, output from the processor 256 may be filtered and terminated at an output connection terminal (such as at composite output 262). Similarly, in some embodiments, output from the processor 256 may be input to one or more electronic video components (such as a DAC 264), which convert the form of the video output, scale the form of the video output or modify the video output in some other way.

An audio output component 276 may also be included and coupled an output of the processor 256 and include an audio DAC 278 and an audio output 280. The audio output component 276 may be configured to provide audio signals to external devices, as a non-limiting example via a RCA-type connector and/or an audio jack. Output from the processor 256 may be filtered and terminated at an output connection terminal. Similarly, in some exemplary embodiments, output from the processor 256 may be input to certain specialized components (such as an Audio Digital to Analog Converter), which convert the form of the audio output or modify the audio output in some other way.

Also included in the presentation device 100 of FIG. 2 is a reset component 286. The reset component 286 may include a reset device 288 to reset an operating system of the presentation device 100. Similarly, the reset component 286 may include a power monitor component 290 for monitoring and/or managing power of the presentation device 100.

Additionally, the processor 256 may be coupled to an Internet protocol (IP) connections component 292 that operates as an interface to other devices via a local area network, a wide area network, and/or the Internet. This would allow the presentation device 100 to receive inputs and/or send outputs via a network connection. Such a network connection may take the form of a wired connection (such as an Ethernet connection) and/or a wireless connection (such as a wireless fidelity (Wi-Fi) connection and/or a Bluetooth connection).

Also included in the exemplary embodiment of FIG. 2, the presentation device 100 may be powered by a set of one or more power rails 298 that connect to power inputs of the electronic components. The power rails 298 may be configured to receive power from an external power source, such as a power cord and/or voltage converter. Similarly, the power rails 298 may be configured to receive power from an internal power source, such as internally mounted replaceable batteries and/or an internal rechargeable battery.

Additionally included is the remote control unit 114, which may be configured to wirelessly communicate to the presentation device 100. The remote control unit 114 may include controls component 210, which may include one or more user keys 212 and a configuration software component 214. In operation, the remote control unit 114 may be configured to transmit one or more instructions to the presentation device 100 utilizing a transmitter 224, such as an RF transmitter 226 and/or an IR transmitter 228. The remote control unit 114 may also include a configuration component that includes a unique identification component 220 and/or other components for identifying the remote control unit 114. The remote control unit 114 may also include one or more status indicators 216 to provide status information of the remote control unit 114 and/or the remote operations.

Additionally, in some embodiments, the remote control unit 114 may include a memory component for storing identification data for one or more presentation devices 100 and a processor for executing instructions from the memory component. Further, in some embodiments, the remote control unit 114 may include a network port (wireless and/or wired) for communicating with remote computers to receive presentation advancement data, presentation device 100 identification data, and/or other data.

One should also know that in some exemplary embodiments, the processor 256 may also include a transmitter. In such embodiments, the remote control unit 114 may include a receiver, such that the presentation device 100 sends data signals to the remote control unit 114.

In operation, the user could connect the presentation device 100 to a display device, such as a projector or monitor, via a video (and/or audio) connection cable.

Also in operation, the user may connect the presentation device 100 to another device via IP connections 292. Using this connection, the user could load data files from a computer or handheld device into the internal memory 230 which represent graphic images that the user intends to display. In some exemplary embodiments, when connected to a computer or other device containing the data files, the presentation device 100 would appear to be a networked memory device, and the user can simply copy files to the presentation device 100. In other embodiments, the presentation device 100 would operate similar to a printer, such that when the user printed a file from the computer to the presentation device 100, the print command would initiate the appropriate file transfer function. In other embodiments, the presentation device 100 would receive files when the user sends and e-mail containing the data file to the presentation device 100. In other embodiments, specialized software could facilitate easy transfer of files from a computer or handheld device to the presentation device 100.

The data files loaded on the presentation device 100 may include business presentation files (such as Adobe files, word processing files, Spreadsheet files, presentation files, such as PowerPoint files, Apple keynote files, Mathematica player files, open document presentation files, open xml presentation files, Lotus freelance graphics files, Staroffice starlmpress files, Thinkfree show files, Corel presentations files, Songshow files, etc.—which are created with corresponding business presentation software), images, videos, audio files, .pdf files, document files, spreadsheet files, and/or other files. Via a configuration file included in the set of data files, a user can specify the order for the presentation by arranging the files in the desired presentation order or default to an alphabetical order.

Upon powering on the presentation device 100, and without any user input, the presentation device 100 checks the files in its memory and queues them up for display according to the desired order. More specifically, upon powering on, the presentation device 100 may determine the first, second, third, etc. slides for buffering. The number of files that are buffered may be predetermined and/or determined based on size of the files and size of the buffer. Additionally, the presentation device 100 may automatically buffer the last, second to last, third to last, etc. files in the presentation. This allows the user to “loop” the presentation from the first slide to the last slide (or vice versa) with little or no delay. The user may the present individual slides of the slideshow presentation via the input devices 102 and/or via the remote control device 114 (FIGS. 1A, 2). One should note that, in at least one embodiment, buffering of files may facilitate seamless transition between files of the same or different formats.

One should note that, in at least one exemplary embodiment, the presentation device 100 may be configured to store a plurality of file types and still present the files in the desired order. As a non-limiting example, if the user has a PowerPoint presentation, images, videos, and/or other files, the user can create the PowerPoint and, instead of having to integrate the images, videos, etc. into the PowerPoint, the user can simply leave these files as separate files. The presentation device 100 will automatically provide the desired files for the presentation.

One should also note that by buffering one or more of the files, the presentation device 100 may automatically instantiate the corresponding application that automatically provides the next file for display. More specifically, if the first file is a .jpg file, the .jpg display application may automatically instantiate to provide the first file. Additionally, the second file may be a PowerPoint presentation (which may include one or more slides). The second slide may be buffered prior to the display of the first slide. Additionally, the application that automatically provides the PowerPoint slides may be instantiated such that upon advancing to the next file, the first slide of the PowerPoint presentation is presented without delay. One should also note that in at least one exemplary embodiment, all applications may be instantiated upon powering on the presentation device 100, thus precluding the desire to instantiate applications in this manner.

FIG. 3 illustrates a non-limiting example of a configuration that utilizes a plurality of presentations devices 100, similar to the diagram from FIGS. 1A and 1B. As illustrated, the configuration of FIG. 3 includes a central remote control device 314 that may be configured to cause a plurality of presentation devices 100a-100d to operate in a synchronized fashion by transmitting instructions to a predetermined presentation device 100 (e.g., 100a) at preprogrammed time intervals, specified times, and/or under certain operational conditions. More specifically, in such configurations, the remote control unit 314 may be configured to receive identification information for each of the presentation devices 100a-100d. As discussed above, the identification information can be received via a wired coupling with a computer and/or via one or more signals received wirelessly from a remote location. Additionally, the remote control unit 314 may be configured to determine a desired sequence for all the presentation devices 100. The remote control unit 314 may then be configured to send trigger signals to the desired presentation devices 100a-100d to provide the desired presentation.

In operation, a user may make a network connection to each of the ports 106a-106d. The presentation devices 100a-100d would receive data files via the network connection from connected computers or other devices.

Additionally, the remote control unit 314 may be configured to receive configuration information that may include identification data for sending signals to each of the presentation devices 100a-100d, as well as a trigger sequence and timing for coordinating an order of slide advancement for the presentation on each of the presentation devices 100. As a non-limiting example, the remote control unit 314 may include a port (e.g., similar to port 106) for coupling (wirelessly and/or wired) to a computer. The computer may include hardware and/or software for sending identifiers of the presentation devices 100a-100d to the remote control unit 314. Additionally, when interfaced with the computer, the configuration information (e.g., order, timing, etc.) may be sent to the remote control unit 314 for each of the presentation devices 100a-100d advance to a next image.

Upon providing the desired configuration information, the remote control unit 314 can store the settings. When a user starts the presentation in automatic mode, the remote control unit 314 can automatically advance through the presentation according to the predetermined slide advancement settings. Similarly, when the user starts the presentation in manual mode, the remote control unit 314 may send a trigger signal to the one or more predetermined presentation devices 100 to advance to the next output (previous output and/or other output) upon a user selection of one or more of the user inputs on the remote control device 314.

As a non-limiting example, the first slide of a presentation may be an image that is displayed on all the presentation devices 100a-100d. However, the second slide may only change the display provided by presentation devices 100a and 100d. Consequently, by pressing a forward command on the remote control unit 314, a signal is only sent to presentation devices 100a and 100d.

Similarly, some embodiments of a multi-presentation device 100 system may be configured as a master-slave configuration. More specifically, if the user desires to coordinate a plurality presentation devices 100, the user may couple a first presentation device 100a to a computer. The user can then select (via the computer) the desired display settings for the presentation. The presentation device 100a can store the desired presentation data. When the presentation device 100a is coupled to a display device (and one or more of the other presentation devices 100b-100d are coupled to display devices), user selects an input on the remote control unit 314 (e.g., advance to the next slide/file). The first presentation device 100a may receive this signal, determine which of the presentation devices 100a-100d is included in the instruction, and send a trigger signal to those presentation devices 100b Additionally, if the presentation device 100a is included in the instruction, the presentation device 100a can also perform the desired operation.

In some embodiments of a multi-presentation device 100 system, control instructions could be sent to each device via the network connection. Each presentation device 100 could have its own IP address. This would allow the devices to be controlled in a variety of ways from a remote site.

FIG. 4 illustrates an exemplary flowchart for a start-up sequence that may be utilized by a presentation device 100, such as the presentation device 100 from FIGS. 1A and 1B. When power is applied to the presentation device 100 (e.g., the presentation device 100 is plugged in and/or turned on with a switch) (block 402), the presentation device 100 be ready to upload a file via its network connection. If the correct code is received indicating a file will be uploaded (block 406), the device will receive the files into its internal memory (block 408). If the presentation device 100 determines that the file being uploaded is a specially configured upgrade file (block 410), it will automatically launch an upgrade routine (block 412 and FIG. 10). If the presentation device 100 determines that each of the files being uploaded is a valid file type (a file type that it has the capability of processing into a video image output), the presentation device 100 will store the file or files as a single presentation (block 420). Once a presentation has been uploaded, the presentation device 100 will initiate the process of queuing up the presentation.

Once powered up, the presentation device 100 could also receive a command to delete a presentation (block 424). If the correct code is received, the presentation device 100 will output the video image of a selection screen. Using the remote control, or buttons on the presentation device 100, or another wirelessly connected control device, the user would select the presentation to be deleted. Once selected, the presentation device 100 would delete that presentation from its internal memory.

FIG. 5 illustrates an exemplary flowchart for queuing up a presentation, similar to the diagram from FIG. 4. The presentation device 100 will determine whether there is one or multiple presentations stored on its internal memory (block 502). If there are multiple presentations, the presentation device 100 will output a video screen of the presentations on the device. Using the remote control, or buttons on the presentation device 100, or another wirelessly connected control device, the user would select the presentation to be displayed (block 506). Once selected, the presentation device 100 would queue that presentation for display. If there was only one presentation in the internal memory, that presentation would be automatically queued for display. In some embodiments, the processor in the presentation device 100 may have an internal time clock function, wherein a presentation is automatically queued at a specific time.

When queuing a presentation for display, the presentation device 100 would determine if one of the files of the presentation was a special configuration file (block 508). If so, a configuration file routine would be initiated to configure the way that the presentation will be displayed.

FIG. 4 also illustrates an exemplary flowchart for an initial buffering of video output files, similar to the diagram from FIG. 5. More specifically, the presentation device 100 can read the first data file (block 512). As a side note, the first file (as well as the order of the data files for presentation) may be set by an order protocol established by a configuration file and/or may default to the order that the data files appear in the internal memory 230. If the data file is a non-displayable file (such as a configuration file), the presentation device 100 may skip the non-displayable file and advance to the next data file, or the first page of the next data file.

If the data file is not a non-displayable file, the presentation device 100 may process the file using a desired data file processing routine (block 514). As discussed in more detail below, the file processing routing may be selected based on the type of file. As a non-limiting example, if the file is a .jpg file, a .jpg reader may be utilized to process the file. The resulting video output file may then be stored in a memory buffer as the “next” slide (block 516).

Similarly, the last data file is similarly read, analyzed and processed. More specifically, the last file may be read (block 518). A determination may then be made regarding whether the last file is a non-displayable file. If not, the last file may be processed by a desired data file processing routine (block 520). The video output file may be stored in the last memory slot (block 522).

Once both video output files are stored in memory, a ready indicator light turns on to let the user know that presentation is ready to show (block 524). Additionally, presentation device 100 may a video output by displaying a start screen (block 526). The start screen may include one or more graphics that allow the user to position and focus their projector or monitor before starting to show pages of their presentation. The process may then proceed to jump block B (block 528), continued in FIG. 6.

One should note that the buffering process described on FIG. 5 and similarly described in following figures may be expanded. More specifically, the presentation device 100 may be configured to pre-processes a plurality of files forward and a plurality of files file backward and store those video files in a buffer. These buffered video output files allow the device to respond to user commands more quickly. Depending on available memory available, additional forward slides and additional backwards slides could be buffered in memory.

FIG. 6 illustrates an exemplary flowchart describing one or more responses of the presentation device 100 to user inputs, similar to the diagram from FIG. 5. Continued from jump block B, the presentation device 100 can determine whether the user has configured it to run in automatic mode (block 622), either by manually configuring switches on the presentation device 100, or by including automatic mode operating instructions in the configuration file.

If the presentation device 100 has been set in automatic mode, it will wait for a user specified time interval and then initiate the forward routine (block 604). Even if the presentation device 100 is operating in automatic mode, it will respond to user inputs via the remote control or other controlling device. For example, the user will be able to return to manual mode at any time.

If the presentation device 100 has not been set in automatic mode, the presentation device 100 may wait for one or more instructions (e.g., one or more user inputs). Once the instruction is received, the presentation device 100 may begin the desired sequence.

More specifically, the presentation device may determine whether a forward signal has been received (block 602). If so, the presentation device 100 may initiate a forward routine (block 604) to advance to a next slide in the presentation.

If the presentation device 100 determines that a reverse signal is received (block 606), the presentation device 100 may initiate a reverse routine (block 608) to advance to the previous slide in the presentation.

If the presentation device determines that a blank signal is received (block 610), the presentation device may initiate a blank routine (block 612) to display a blank screen during the presentation. If the presentation device 100 determines that a “first” signal is received (block 614), a “first” routine may be initiated (block 616).

In other embodiments the presentation device 100 will respond to “other” types of command signals, which expand the functionality of the presentation device 100 or specialize it for a certain application. If the presentation device 100 determines that such “other” signal is received (block 828), a corresponding routing may be initiated (block 830).

FIG. 7A illustrates exemplary flowcharts for the presentation device 100 to sequence images, similar to the diagram from FIG. 6. These sequences occur when the presentation device 100 receives a forward or reverse signal from a user input. More specifically, if the presentation device 100 receives a forward signal, the presentation device 100 can provide the video output file in the next +1 memory buffer position for display (702). The presentation device 100 can then store the prior video output in the next −1 buffer position (block 704). The next data file may then be read (block 706). A determination can be made whether the data file is a non-displayable file. If so, the presentation device 100 can read the next data file. If not, the presentation device 100 can initiate a data file processing routine (block 708). The video output file may then be displayed in memory position next +1 (block 710).

Similarly, if the presentation device 100 receives a reverse signal, the presentation device 100 may output the video image stored in the next −1 memory buffer position (block 714). Similarly, the video image that was previously displayed is stored in the next +1 memory buffer position (block 716). The presentation device 100 can then read the previous data file (block 718). The presentation device 100 may also determine whether the file is a non-displayable file. If so, the process returns to block 718. If the file is not a non-displayable file, a data file processing routine may be initiated (block 720). The presentation device 100 may then store the video image in the previous memory position (block 722).

As noted earlier, the buffering process described in FIGS. 10A and 10B may be expanded. Depending on the memory available in the presentation device 100, additional video images could be stored in both the forward and reverse direction. This allows the presentation device 100 to respond more quickly to user input.

FIG. 7B is an exemplary flowchart for processing of data files, similar to the diagram from FIG. 7A. More specifically, FIG. 7B illustrates an expanded version of block 708, from FIG. 7A. As illustrated, in processing the current file, the presentation device 100 may determine the type of file being processed (block 726). If it is determined that the file is a PowerPoint file, a PowerPoint application may be utilized to create a displayable image of the file (block 732). The PowerPoint application may be configured to automatically present the file in the desired format. Additionally, as discussed in more detail below, if the file is a PowerPoint file, the presentation device may be configured to cycle through the one or more slides of the PowerPoint file before proceeding to the next file of the presentation stored in internal memory 230.

Additionally, the PowerPoint application (and/or other applications in FIG. 7B) may be a routine built into the processor 256 (such as a special codec) of the presentation device 100, and/or be an application contained in the embedded software system (e.g., memory 282, 284).

Returning to FIG. 7B, if the presentation device 100 determines that the file is a jpeg file, a jpeg application may be used to create a displayable image file (block 732). Similarly, if the file is a pdf file, a pdf application may be used to create a displayable image file (block 732). If the presentation device 100 determines that the file is another supported file type, an appropriate application may be utilized to process the file (block 732).

FIG. 7B also illustrates an exemplary flowchart for processing images into a video output of the presentation device 100. If the file is a movie file (e.g., .mpeg, etc.), the presentation device may create a bookmark for the movie file. When the file is selected as the next file and the bookmark is encountered, the presentation device 100 will start output of the movie video image in real time (block 730). As a non-limiting example, if the file is an .mpeg file, an mpeg decoder application would be initiated. If the file is an .avi file, an .avi decoder application may be initiated.

One should note that in some exemplary embodiments, the presentation device 100 is configured to adding and/or amending the supported file types. More specifically, while the presentation device 100 may be factory shipped with no supported file types and/or a predetermined number (nonzero) of file types, the user may update the presentation device to change the supported file types. This may be desirable when new file types are developed and/or when a particular presentation utilizes one or more file types not previously utilized. Additionally, the updating of supported file types may occur via a user coupling the presentation device 100 to a computer and actively selecting associated plugins to support the desired file types. Similarly, some embodiments may be configured such that upon uploading the file into internal memory 230, the presentation device 100 determines whether any of the files are not supported and, if so, alerts the user and/or automatically downloads the corresponding plugins.

FIG. 8 illustrates an exemplary flowchart for utilizing a blank function and first function on the presentation device 100, similar to the diagram from FIG. 7.

More specifically, FIG. 8 illustrates block 612 from FIG. 6. As illustrated, in FIG. 8, if the blank signal is received (such as via a user pushing the blank button), the presentation device 100 may output the video image of a blank screen (block 802). The presentation device 100 may then wait for any user input (block 804). If input is received from the user, the presentation device 100 may resume outputting the previously displayed video image (block 806). Additionally, in some embodiments, stopping the video output of the blank image might require a specific user input, such as another push of the blank button.

More specifically, FIG. 8 also illustrates s block 616, from FIG. 6. As illustrated in FIG. 8, if the presentation device 100 receives a “first” signal as a result of a user input, the presentation device 100 may then read the first data file (block 810). As described previously, the first data may be determined by default and/or via a special configuration file. If the file is a non-displaying file, the next file may be read. If however, the file is not a non-displaying file, the data file may be processed into a video image using a desired processing routine (block 812), as described in FIG. 7B. The presentation device 100 would then queue up the presentation starting with slide 1 (blocks 810 through 820).

FIG. 9 illustrates an exemplary flowchart for configuration file processing with the presentation device 100, similar to the diagram from FIG. 8. More specifically, FIG. 14 illustrates a detailed view of block 508, from FIG. 5. As discussed above, if the presentation device 100 determines that a file contained in the presentation stored in internal memory 230 is a configuration file, the presentation device 100 may initiate a process to utilize the information in the configuration file. As illustrated in FIG. 9, to facilitate this, the presentation device can determine the contents of the configuration file (block 902). Configuration files may be text files that provide configuration instructions to the presentation device 100. If the presentation device 100 determines that the configuration file includes a desired data file order, the presentation device 100 may set the file order according to the configuration file (block 904). Similarly, if the presentation device determines that configuration file includes data for configuring one or more security options, the presentation device 100 can set security protocols (block 906). As a non-limiting example, the configuration file may be configured to turn on a feature to place a watermark image and/or a serial number image on each video image that is output by the presentation device.

Also as a non-limiting example, the configuration file may limit the number of times that a presentation can be viewed, or may required a physical or software security key be present to access the presentation, or may only allow viewing the file for a certain range of dates. Also as a non-limiting example, the configuration file may cause the presentation device 100 to automatically delete a set of presentation data files at a certain time or as a result of a certain event.

Similarly, as another non-limiting example, the configuration file may include an identification number to match with the built-in identifier of the presentation device 100. If the configuration file identification does not match the built-in identifier, the presentation device 100 may disable processing of data files stored in internal memory 230. Additionally, an error screen may be provided for display.

Additionally, if the presentation device 100 determines that the configuration file includes information to allow multi-unit information, the presentation device 100 can set the presentation device for multi-device operations (block 908). As a non-limiting example, the configuration file may include a sequencing ID for the presentation device 100. If the presentation device 100 receives a command from the remote control unit 314 that includes this sequencing ID, the presentation device can respond the command. Commands without the sequencing ID would be ignored by the presentation device 100.

Similarly, in a master-slave multi-device configuration, the configuration file may include identifiers for each presentation device 100a-100d and an indication of whether the presentation device 100 is a master or slave. This allows the master to send trigger signals to the slaves, based on the received presentation.

Other configuration options can also available in the presentation device 100 via upgrades in its embedded software (block 910). This would allow for future expansion of functionality or a specialized configuration for a certain application.

FIG. 10 illustrates an exemplary flowchart of a embedded software upgrade routine function that may be utilized on the presentation device 100, similar to the diagram from FIG. 9. More specifically, the embodiment of FIG. 10 illustrates a detailed view of block 4412, from FIG. 4. As illustrated in FIG. 4, if an upgrade file is received into internal memory 236, the presentation device 100 may initiate a software upgrade routine.

Once the upgrade routine is started, the presentation device 100 may determine whether a upgrade file has been uploaded (1002). If so, the presentation device 100 may perform one or more checks on the data file. As a non-limiting example, the presentation device 100 may check the header information on the file (block 11004). If the header is acceptable, the presentation device 100 can verify the hardware integrity of the presentation device 100 (block 1006). If the hardware is acceptable, the presentation device may authenticate the source of the upgrade file (block 1008).

If the upgrade file does not pass one or more of these checks, the presentation device 100 may output a video image of an error screen (block 1018). In some embodiments, this error could be cleared by cycling the power to the presentation device 100.

If the upgrade file passes all of the checks (blocks 1004-1008), the presentation device 100 can output an “upgrade in process” screen video image (block 1010). The presentation device 100 can then install the upgrade into flash memory 282. If the upgrade fails, a failed upgrade screen may be provided (block 1018). If however, the upgrade is completed, an upgrade complete screen may be provided (block 1016). In some embodiments, the upgrade routine may include protection, by not overwriting the original embedded software until the new embedded software upgrades have been fully installed and checked.

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. As a non-limiting example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, as a non-limiting example but not limited to, an electronic, magnetic, optical, electromagnetic, infrared, or semiconductor system, apparatus, or device. More specific examples (a non-exhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A presentation device comprising:
internal memory storage capable of storing at least one file;
video and audio output ports which provide the capability to connect the device to external display devices;
a port providing the capability to connect the device to a network;
a processing component running an embedded software system; the processing component and embedded software system configured to convert certain data files types into video and audio output signals that can be viewed and heard on external devices.

2. The presentation device of claim 1, the internal memory storage, the port, the processing component and embedded software configured to be capable of receiving data files from external devices connected to it via the network, and automatically determining whether the data files are types that can be processed into video and audio signals displayable on an external display device.

3. The presentation device of claim 1 and claim 2, in which the processing component and embedded software will advance from one image to the next or delete files and presentations based on triggering commands received:
from an external device communicating to the presentation device via a wired or wireless networked connection using the device's port;
a companion remote control unit;
or specialized remote device.

4. The presentation device of claim 1, wherein the internal memory contains a plurality of files, wherein each of the plurality of files is configured in a different format, and wherein the processing component is further configured to convert each of the plurality of files into a sequence of signals for presentation as a plurality of viewable images.

5. The presentation device of claim 4, the processing component further configured to convert each of the plurality of files into the sequence of signals for display such that transition of display from a first file of the plurality of files to a second file of the plurality of files is seamless.

6. The presentation device of claim 4, wherein the processing component can automatically determine if one of the plurality of files is a configuration file containing information and instructions about how the plurality of files should be processed, and then automatically configuring the presentation device to output video and audio signals consistent with the configuration file instructions.

7. The configuration file of claim 6, wherein the configuration file contains security provisions, including one or more of the following:
limits to the number of times files can be displayed;
limits to ability to view files based on calendar time;
requirement to provide a certain user code before a files can be displayed;
automatic deletion of files and presentations after a certain number of viewings or after a specified calendar time.

8. The presentation device of claim 1, wherein the processing component contains a time function such that files can be automatically queued for a presentation at specified times.

9. The presentation device of claim 1, wherein the processing component and embedded software are capable of automatically outputting video and audio signals and advancing from one image or file to the next in a continuous loop.

10. The presentation device of claim 4, where wherein at least one of the plurality of files is a business presentation file created with business presentation software and at least one other file of the plurality of files is in a format not created by the business presentation software and wherein the processing component is configured to convert the sequence of signals such that the presentation provides a seamless transition between the business presentation file and the at least one other file.

11. The presentation device of claim 1, wherein the processing component is further configured to automatically performance of an embedded software update of the presentation device when it detects that a software upgrade file has been loaded into its internal memory.

12. The presentation device of claim 1, wherein the processing component will configure the presentation device for coordinated multi-device operation based on at least one parameters contained in a configuration file which has been loaded into the device's internal memory.

13. The presentation device of claim 1, wherein a configuration file has been loaded into the internal memory containing at least the following information: a file order for the at least one presentation, at least one security protocol, and at least one parameter for the multi-device presentation.

14. The presentation device of claim 1, wherein the processing component can automatically prompt the user to choose files or a presentation for display when multiple files or presentations have been loaded into the device's internal memory.

15. The presentation device of claim 1, including a viewable display integrated with the device.

16. The presentation device of claim 3, wherein a user could simultaneously cause multiple presentation devices in multiple locations to display the same image, by first uploading files into the internal memory of multiple presentation devices and then simultaneously sending a triggering signal to all connected devices.

17. The presentation device of claim 2, wherein the uploading of files into the presentation device's internal memory does not disrupt a presentation in progress.

18. The presentation device of claim 2, wherein the uploading of files into the presentation device's internal memory is accomplished by:
printing files to the presentation device (the presentation device appears to a remote computer or handheld device as a printer);
or e-mailing a files to the presentation device (the presentation device appears to a remote computer or handheld device as an e-mail client);
or copying files to the presentation device (the presentation device appears as a memory device on the network).

19. The presentation device of claim 2, wherein users can access a remote server through the presentation device and download files from the remote server via commands to the presentation device.
